(19) United States
(12) Patent Application Publication
(10) Pub. No.: US 2008/0003961 A1
(43) Pub. Date: Jan. 3, 2008

(54) APPARATUS AND METHOD FOR SCANNING RADIO WAVES

(75) Inventors: Victor A. Acuna, Rochester, MN (US); Lee Nee, Rochester, MN (US); Steven M. Miller, Cary, NC (US); Omar E. Perez, Raleigh, NC (US); Jamie E. Rivera-Cordero, Rochester, MN (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/427,667

(22) Filed: Jun. 29, 2006

(51) Int. Cl. H04B 1/18

(52) U.S. Cl. 455/161.1

(57) ABSTRACT

An apparatus for scanning radio waves including a scanner in operable communication with a radio receiver, the scanner further including a monitor module configured to scan a plurality of radio waves in real time. The monitor module is further configured to extract audio samples containing information. The scanner further includes a memory module in communication with the monitor module. The memory module is configured to receive the extracted audio sample data from the monitor module. The memory module is further configured to store the extracted audio sample data. The scanner further includes an audio analyzer module in communication with the memory module. The audio analyzer module is configured to analyze the extracted audio sample data and classify the extracted audio sample data into a particular content category. The scanner further includes a content aggregation module and a second memory module communicating with the content aggregation module.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to radio receivers, and more particularly, to an apparatus and method for scanning radio waves.

2. Description of Background

Radio is the dominant means of communication that reaches the largest amount of people, more than television or the internet Radio transmissions that are broadcast may include programming data from the stations; many broadcast radio waves are full of programming and commercials that are difficult to sort.

Channel surfing is time consuming and sometimes impractical with a radio. People spend a lot of time surfing because they do not know when their favorite songs or radio shows are being played. Marketing opportunities are therefore lost or limited to specific audiences because many people keep the radio set on the same station or prefer to turn their radio off instead of continuously switching stations.

Thus, there is a need for an apparatus and method for scanning radio waves such that a user can have knowledge about when their favorite songs and radio shows are being played by extracting that data from the sub-carrier channel's contents contained in the radio waves. Furthermore, there is a need for allowing the user to be able to save the extracted data for play on the radio at a later time.

### SUMMARY OF THE INVENTION

The shortcomings of the prior art are overcome and additional advantages are provided through the provision of an apparatus for scanning radio waves, including a scanner in operable communication with a radio receiver, the scanner further including a monitor module configured to scan a plurality of radio waves in real time. The monitor module is configured to extract audio samples containing information therein representing one or more of: the originating radio station, genre, song, and next song transmitted from each of the plurality of radio waves. The scanner further includes a memory module in communication with the monitor module. The memory module is configured to receive the extracted audio sample data from the monitor module. The memory module is further configured to store the extracted audio sample data. The scanner further includes an audio analyzer module in communication with the memory module. The audio analyzer module is configured to analyze the extracted audio sample data and classify the extracted audio sample data into a particular content category. The scanner further includes a content aggregation module in communication with the audio analyzer module. The content aggregation module is configured to build a multiple content stream of data based on user preferences. The content aggregation module is further configured to generate a content guide from the extracted audio sample data that correlates to the user established content preference data. The scanner further includes a second memory module in communication with the content aggregation module. The second memory module is configured to store the content guide generated by the content aggregation module such that the content guide can be activated for play at a later time period.

The shortcomings of the prior art are overcome and additional advantages are provided through the provision of a method for scanning radio waves including scanning a plurality of radio waves in real time. Then extracting audio samples from the scanned radio waves, the audio samples containing information representing one or more of: the originating radio station, genre, song, next song and other data transmitted by each of the plurality of radio waves. Then storing the extracted audio sample data in memory.

Then analyzing the extracted audio sample data and classifying the extracted audio sample data into a particular content category. Then the method proceeds by building a multiple content stream of data and using the multiple content stream of data to generate a content guide available for play at a later time period. Then storing the generated content guide in a memory so as to render the content guide available for play at a later time period. The shortcomings of the prior art are overcome and additional advantages are provided through the provision of a computer program product for scanning radio waves. The computer program product including a storage medium readable by a processing circuit and storing instructions for execution by the processing circuit for performing a method including scanning a plurality of radio waves in real time. Then extracting audio samples from the scanned radio waves. The audio samples containing information representing one or more of: the originating radio station, genre, song, next song and other data transmitted by each of the plurality of radio waves. Then storing the extracted audio sample data in memory. Then analyzing the extracted audio sample data and classifying the extracted audio sample data into a particular content category. Then building a multiple content stream of data and using the multiple content stream of data to generate a content guide. Then storing the generated content guide in memory so as to render the content guide available for play at a later time period.

Additional features and advantages are realized through the techniques of the proposed invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for an apparatus and a method for scanning radio waves.

### BRIEF DESCRIPTION OF THE DRAWING

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram illustrating one example of a scanner in accordance with an embodiment of the present invention;

FIG. 2 is a schematic diagram illustrating one example of a plurality of radio stations broadcasting; and

FIG. 3 is an alternative embodiment of the invention shown in FIG. 1.

The detailed description explains the preferred embodiments of the invention, together with advantages and features, by way of example with reference to the drawings.

### DETAILED DESCRIPTION OF THE INVENTION

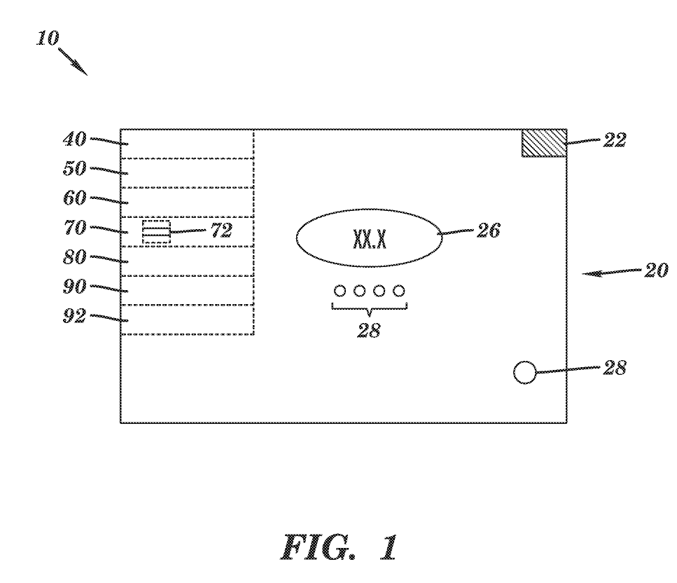

Referring to FIG. 1, a scanner 10 operably connected to a radio receiver 20 for scanning radio waves is illustrated. The scanner 10 includes a monitor module 40, a first memory module 50, an audio analyzer module 60, a content aggregation module 70, and a second memory module 80.

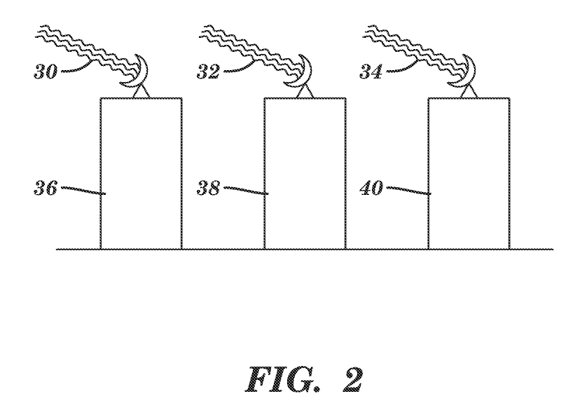

The monitor module 40 is configured to scan a plurality of radio waves 30, 32 and 34 in real time, as shown in FIG. 2. The plurality of radio waves 30, 32 and 34 are broadcast by a plurality of radio stations 36, 38 and 40, respectively. The radio waves 30, 32 and 34 contain data such as, for example, song genre, song, next song, etc. This data is part of the sub-carrier channel's contents transmitted by the radio stations 36, 38 and 40 and contained in the radio waves 30, 32 and 34. The monitor module 40 is configured to extract audio samples that represent the data transmitted in the radio waves 30, 32 and 34. Once the radio waves 30, 32 and 34 have been broadcast, an antenna 22 associated with the radio receiver 20 receives the radio waves 30, 32 and 34 and transmits the information contained therein to the monitor module 40.

The disclosed scanner 10 is not limited to only implementations involving radio stations 36, 38 and 40 as depicted in FIG. 2. The disclosed scanner 10 may be utilized on other types of radio content transmission, for example, satellite radio, etc.

The first memory module 50 is in communication with the monitor module 40. The monitor module 40 transmits the extracted audio sample data acquired from the sub-carrier channel's content that is contained in the radio waves 30, 32 and 34. The data is transmitted to the memory module 50, which is configured to receive and store the extracted audio sample data.

The audio analyzer module 60 is in communication with the memory module 50. The memory module 50 transmits the extracted audio sample data to the audio analyzer module 60. The audio analyzer module 60 is configured to analyze the extracted audio sample data. The audio analyzer module 60 is also configured to classify the extracted audio sample data into a particular content category. This classification may be performed by analyzing sound patterns to determine genre (e.g., news, rock, classic, etc.) or by using an RSS (web format) feed delivered over the network for additional content such as a podcast, for example.

The content aggregation module 70 is in communication with the audio analyzer module. Content aggregation is the idea of seamlessly switching between sources, either buffered or live. The content aggregation module 70 is configured to build a multiple content stream of data based upon user preferences such as artist, title, etc. Once the multiple content stream of data is built, the content aggregation module 70 generates a content guide 72 from the sample data that correlates to the user established content preference data. For example, a rock genre aggregation may be built from various artist and stations. Once compiled, the rock genre shall play continuously until it ends. New material may be added to the aggregation on demand, as it becomes available. Multiple aggregations may be built simultaneously and the user may continuously switch between them. Audio and visual queues are utilized to notify the user of new or updated aggregations and how to access them.

The real time updates and available buffered content that has not been accessed or provided to the user is used to generate new seamless content aggregations that the user might be interested in accessing. These updates are used to re-program the user interface and notify the user of the new aggregations and allow the user to switch to another one. The new aggregations have a genre, artist, or other type of relationship and also have values for duration, number of content, elements, etc., which are used to weigh the various aggregations against each other for ordering. The scanner 10 uses an item and/or duration threshold to decide when a new aggregation will be added to the list and the user then notified.

For example, the user might be accessing a content aggregation of five rock genre songs for duration of twenty-eight minutes. The user is also interested in jazz genre songs. Once enough jazz content is identified in either live broadcast or previously buffered content to meet or exceed the threshold, a new aggregation is created and the user is notified by an audible sound, flashing button or on-screen-display that six jazz genre songs for a duration of forty nine minutes is available. The user then has the option to switch to the new seamless stream of aggregated content.

If the user is pleased with the content (a song, a show, etc.), the scanner 10 provides options to allow the user to tag the content as a favorite. If available the user would receive a higher-quality or extended version of the content in real time or optionally, be able to access such versions by downloading directly to the user's device, uploading to a user repository or have a URL sent to the user's e-mail address. The scanner 10 may contain an additional content purchasing module 92 that allows the user to access, store, and compare available content for purchase.

The second memory module 80 is in communication with the content aggregation module 70. The second memory module 80 is configured to store the content guide 72 generated by the content aggregation module 70 such that the content guide 72 can be activated for play at a later time period.

The scanner 10 further includes a discriminator module 90 used to control radio station scan operations performed by the monitor module 40. The discriminator module 90 is configured to, for example, provide a scan of the plurality of radio waves 30, 32 and 34 generated by the plurality of radio stations 36, 38 and 40, respectively, the scan only occurs for particular stations (e.g., such as radio stations 36 and 38 but not radio station 40) according to at least one preferred content category. The preferred content category is previously determined by user selection based upon the user's interaction with a control panel 22 on the radio receiver 20. The user plays certain music by operating various control actuators 24 on the control panel 22 that tune to different channels displayed on a display 26 disposed on the control panel 22. The radio receiver 20 is powered up by activating an on/off switch 28 operably connected to the internal circuitry of the radio receiver.

The scanner 10 allows for at least one content category to be determinable by the monitor module 40 during the monitoring of the plurality of radio waves 30, 32 and 34 generated by the plurality of radio stations 36, 38 and 40, respectively, and chosen by the user for more than a predetermined listening time. A listening sample is extracted from each monitored radio station 36, 38 and 40 selected by the user for more than a predetermined time. The audio analyzer module 60 analyzes each extracted listening audio sample to determine at least one preferred content category.

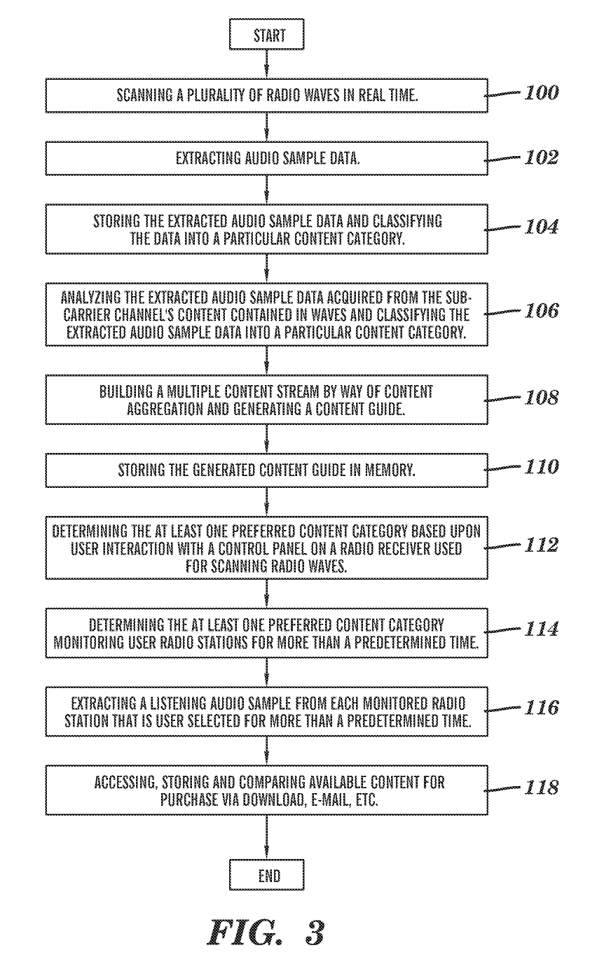

Referring to FIG. 3, a method for scanning radio waves in accordance with another exemplary embodiment will now be explained.

The method begins at block 100 by scanning a plurality of radio waves 30, 32 and 34 broadcast by one or more radio stations 36, 38 and 40 in real time.

The method proceeds as shown in block 102 by extracting audio samples from the sub-carrier channel's content contained in the scanned radio waves 30, 32 and 34.

The method proceeds as shown in block 104 by storing the extracted audio sample data in a first memory 50.

The method proceeds as shown in block 106 by analyzing the extracted audio sample data and classifying the extracted audio sample data into a particular content category.

The method proceeds as shown in block 108 by building a multiple content stream of data by way of content aggregation and using the multiple content stream of data to generate a content guide 72 that correlates to the user established content preference data.

The method proceeds as shown in step 110 by storing the generated content guide 72 in a memory 80 so as to render the content guide 72 available for play at a later time period.

The scan of the plurality of radio waves 30, 32 and 34 generated by the plurality of radio stations 36, 38 and 40, only occurs for particular stations according to at least one preferred content category.

The method proceeds as shown in step 112 by determining the at least one preferred content category based upon user interaction with a control panel 22 on a radio receiver 20 used for scanning the plurality of radio waves.

The method proceeds as shown in step 114 by determining the at least one preferred content category monitoring user radio stations 36, 38 and 40 for more than a predetermined listening time.

The method proceeds as shown in step 116 by extracting a listening audio sample from each monitored radio station 36, 38 and 40 that is user selected for more than a predetermined time. Each extracted listening audio sample is analyzed to determine at least one preferred content category.

At step 118, the user may access, store and compare available content for purchase. The delivery of the content may be configured to be obtained via download to the scanner 10, delivery to the user's e-mail, etc.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the disclosed invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An apparatus for scanning radio waves comprising:
a scanner in operable communication with a radio receiver, the scanner further comprising
a monitor module configured to scan a plurality of radio waves in real time, the monitor module configured to extract audio samples containing information therein representing one or more of: the originating radio station, genre, song, and next song transmitted from each of the plurality of radio waves;
a memory module in communication with the monitor module, the memory module configured to receive the extracted audio sample data from the monitor module, the memory module further configured to store the extracted audio sample data;
an audio analyzer module in communication with the memory module, the audio analyzer module configured to analyze the extracted audio sample data and classify the extracted audio sample data into a particular content category;
a content aggregation module in communication with the audio analyzer module, the content aggregation module configured to build a multiple content stream of data based on user preferences, the content aggregation module further configured to generate a content guide from the sample data that correlates to the user established content preference data; and
a second memory module in communication with the content aggregation module, the second memory module configured to store the content guide generated by the content aggregation module such that the content guide can be activated for play at a later time period.

2. The apparatus of claim 1, further comprising:
a discriminator module configured to control the scan operation such that the scan of the plurality of radio waves occurs according to at least one preferred content category.

3. The apparatus of claim 2, wherein the preferred content category is previously determined by user selection based upon the user's interaction with a control panel on the radio receiver.

4. The apparatus of claim 3, wherein the at least one preferred content category is determined by the monitor module during the monitor of the plurality of radio waves generated by the source chosen by the user for more than a predetermined listening time.

5. The apparatus of claim 4, wherein a listening audio sample is extracted from each monitored source the user selects for more than a predetermined time, each extracted listening audio sample is analyzed by the audio analyzer module to determine at least one preferred content category.

6. The apparatus of claim 5, further including a content purchasing module configured to allow the user to access, store and compare available content for purchase.

7. A method for scanning radio waves, comprising:
scanning a plurality of radio waves in real time;
extracting audio samples from the scanned radio waves, the audio samples containing information representing one or more of: the originating radio station, genre, song, next song and other data transmitted by each of the plurality of radio waves;
storing the extracted audio sample data in memory;
analyzing the extracted audio sample data and classifying the extracted audio sample data into a particular content category;
building a multiple content stream of data and using the multiple content stream of data to generate a content guide; and
storing the generated content guide in memory so as to render the content guide available for play at a later time period.

8. The method of claim 7, wherein:
the scan of the plurality of radio waves occurs according to at least one preferred content category.

9. The method of claim 8, further comprising:
determining the at least one preferred content category based upon user interaction with a control panel on a radio receiver used for scanning the plurality of radio waves.

10. The method of claim 9, further comprising:
determining the at least one preferred content category monitoring user selected radio stations for more than a predetermined listening time.

11. The method of claim 10, further comprising:
extracting a listening audio sample from each monitored source that is user selected for more than a predetermined time, and analyzing each extracted listening audio sample to determine at least one preferred content category.

12. The method of claim 11, further comprising:
accessing, storing and comparing available content for purchase.

13. A computer program product for scanning radio waves, the computer program product comprising:
a storage medium readable by a processing circuit and storing instructions for execution by the processing circuit for performing a method comprising:
scanning a plurality of radio waves in real time;
extracting audio samples from the scanned radio waves, the audio samples containing information representing one or more of: the originating radio station, genre, song, next song and other data transmitted by each of the plurality of radio waves;
storing the extracted audio sample data in memory;
analyzing the extracted audio sample data and classifying the extracted audio sample data into a particular content category;
building a multiple content stream of data and using the multiple content stream of data to generate a content guide; and
storing the generated content guide in memory so as to render the content guide available for play at a later time period.
